(19) United States
(12) Patent Application Publication
(10) Pub. No.: US 2018/0270305 A1
(43) Pub. Date: Sep. 20, 2018

(54) SYSTEMS AND METHODS FOR THROTTLING INCOMING NETWORK TRAFFIC REQUESTS

(71) Applicant: Google Inc., Mountain View, CA (US)

(72) Inventors: Christopher Tignor, Mountain View, CA (US); Steven Delong, Mountain View, CA (US); Umar Syed, Mountain View, CA (US); Samuel Frank, Mountain View, CA (US); Scott Gilpin, Mountain View, CA (US); Tammy Wu, Mountain View, CA (US)

(73) Assignee: Google Inc., Mountain View, CA (US)

(21) Appl. No.: 15/462,679

(22) Filed: Mar. 17, 2017

(51) Int. Cl. H04L 29/08

(52) U.S. Cl. CPC H04L 67/1008; H04L 67/327; H04L 67/322

(57) ABSTRACT

Systems and methods of throttling incoming network traffic requests are provided. A data processing system can receive a request from a computing device via a computer network. The data processing system can determine a predicted number of incoming requests and a current available capacity of the data processing system. The data processing system, responsive to determining that the current available capacity of the data processing system is insufficient to process the predicted number of incoming requests, can assign a prioritization value to the request and determine a throttling threshold value based on the current available capacity of the data processing system, the predicted number of incoming requests, and a distribution of historical prioritization values. The data processing system can throttle the request responsive to determining that the prioritization value is below the determined throttling threshold value.

### BACKGROUND

In a computer networked environment such as the internet, client devices transmit requests to one or more servers for processing of the requests. The servers that process these requests have finite computing resources, which can adversely affect the servers' ability to process these requests when a large number of requests are waiting to be processed.

### SUMMARY

At least one aspect is directed to a method of throttling incoming network traffic requests. The method includes receiving, by a data processing system comprising one or more processors, a request from a computing device via a computer network. The request comprises one or more attributes associated with the computing device. The method includes determining, by the data processing system, a predicted number of incoming requests for a first time period. The method includes determining, by the data processing system, a current available capacity of the data processing system for processing incoming requests. The method includes determining, by the data processing system, that the current available capacity of the data processing system is insufficient to process the predicted number of incoming requests. The method includes responsive to determining that the current available capacity of the data processing system is insufficient to process the predicted number of incoming requests, (i) assigning, by the data processing system, a prioritization value to the request based on the one or more attributes associated with the computing device, and (ii) determining, by the data processing system, a throttling threshold value based on the current available capacity of the data processing system, the predicted number of incoming requests for the first time period, and a distribution of historical prioritization values corresponding to a second time period. The method includes determining, by the data processing system, that the prioritization value assigned to the request is below the determined throttling threshold value. The method includes throttling, by the data processing system, the request responsive to determining that the prioritization value assigned to the request is below the throttling threshold.

In some implementations, the method further includes determining a latency sensitivity level of the request, and assigning the prioritization value to the request based on the determined latency sensitivity level of the request using a latency prioritization rule in a prioritization policy used to assign the prioritization value.

In some implementations, the method further includes determining a geographic location of the computing device sending the request, and assigning the prioritization value to the request based on the determined geographic location of the computing device using a geographic location prioritization rule in the prioritization policy. In some implementations, the geographic location of the computing device is determined based on an Internet Protocol (IP) address of the computing device.

In some implementations, the method further includes receiving, by the data processing system, a second request from a second computing device via the computer network during the first time period. The method further includes assigning, using the prioritization policy, a second prioritization value to the second request based on one or more characteristics of the second request. The method further includes determining, by the data processing system, that the second prioritization value assigned to the second request is above the determined throttling threshold value. The method further includes processing, by the data processing system, the second request responsive to determining that the prioritization level assigned to the second request is above the throttling threshold.

In some implementations, the method further includes receiving, by the data processing system, a third request from a third computing device via the computer network. The method further includes determining, by the data processing system, a second predicted number of incoming requests for a third time period. The method further includes determining the current available capacity of the data processing system for processing incoming requests. The method further includes determining that the current available capacity of the data processing system is sufficient to process the second predicted number of incoming requests. The method further includes processing, by the data processing system, the third request responsive to determining that the current available capacity of the data processing system is sufficient to process the second predicted number of incoming requests.

In some implementations, the current available capacity of the data processing system is determined based on a memory capacity, a disk capacity, and a processor capacity of the data processing system. In some implementations, throttling the request further comprises skipping processing the request.

At least one aspect is directed to a system for throttling incoming network traffic requests. The system can include a memory and one or more processors coupled to the memory. The one or more processors can be configured to receive a request from a computing device via a computer network, determine a predicted number of incoming requests for a first time period, determine a current available capacity of a data processing system for processing incoming requests, and determine that the current available capacity of the data processing system is insufficient to process the predicted number of incoming requests. The received request comprises one or more attributes associated with the computing device. The one or more processors can further be configured to, responsive to determining that the current available capacity of the data processing system is insufficient to process the predicted number of incoming requests, (i) assign, using a prioritization policy, a prioritization value to the request based on the one or more attributes associated with the computing device, and (ii) determine a throttling threshold value based on the current available capacity of the data processing system, the predicted number of incoming requests for the first time period, and a distribution of historical prioritization values corresponding to a second time period. The one or more processors can further be configured to determine that the prioritization value assigned to the request is below the determined throttling threshold value, and throttle the request responsive to determining that the prioritization value assigned to the request is below the throttling threshold.

In some implementations, the one or more processors can further be configured to determine a latency sensitivity level of the request, and assign the prioritization value to the request based on the determined latency sensitivity level of the request using a latency prioritization rule in the prioritization policy.

In some implementations, the one or more processors can further be configured to determine a geographic location of the computing device sending the request, and assign the prioritization value to the request based on the determined geographic location of the computing device using a geographic location prioritization rule in the prioritization policy. In some implementations, the geographic location of the computing device is determined based on an Internet Protocol (IP) address of the computing device.

In some implementations, the one or more processors can further be configured to receive a second request from a second computing device via the computer network during the first time period, assign a second prioritization value to the second request based on one or more characteristics of the second request using the prioritization policy, determine that the second prioritization value assigned to the second request is above the determined throttling threshold value, and process the second request responsive to determining that the prioritization level assigned to the second request is above the throttling threshold.

In some implementations, the one or more processors can further be configured to receive a third request from a third computing device via the computer network, determine a second predicted number of incoming requests for a third time period, determine the current available capacity of the data processing system for processing incoming requests, determine that the current available capacity of the data processing system is sufficient to process the second predicted number of incoming requests, and process the third request responsive to determining that the current available capacity of the data processing system is sufficient to process the second predicted number of incoming requests.

At least one aspect is directed to a non-transitory computer-readable medium having machine instructions stored therein. The instructions when executed by at least one processor, causing the at least one processor to perform operations comprising receiving a request from a computing device via a computer network, determining a predicted number of incoming requests for a first time period, determining a current available capacity of the data processing system for processing incoming requests, and determining that the current available capacity of the data processing system is insufficient to process the predicted number of incoming requests. The received request comprises one or more attributes associated with the computing device. The instructions can further cause the at least one processor to perform operations comprising, responsive to determining that the current available capacity of the data processing system is insufficient to process the predicted number of incoming requests, (i) assigning, using a prioritization policy, a prioritization value to the request based on the one or more attributes associated with the computing device, and (ii) determining a throttling threshold value based on the current available capacity of the data processing system, the predicted number of incoming requests for the first time period, and a distribution of historical prioritization values corresponding to a second time period. The instructions can further cause the at least one processor to perform operations comprising determining that the prioritization value assigned to the request is below the determined throttling threshold value, and throttling the request responsive to determining that the prioritization value assigned to the request is below the throttling threshold.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one implementation of a system for throttling incoming network traffic requests, according to an illustrative implementation.

FIG. 2 is a block diagram depicting one implementation of a request throttling engine, according to an illustrative implementation.

FIG. 3 is a flow diagram depicting a method of throttling incoming network traffic requests, according to an illustrative implementation.

FIG. 4 is a block diagram depicting an illustrative implementation of a general architecture for a computer system that may be employed to implement elements of the systems and methods described and illustrated herein.

### DETAILED DESCRIPTION

Following below are more detailed descriptions of various concepts related to, and implementations of, methods, apparatuses, and systems of throttling incoming network traffic requests in a computer network environment. The various concepts introduced above and discussed in greater detail below may be implemented in any of numerous ways, as the described concepts are not limited to any particular manner of implementation.

The disclosure relates to systems and methods of throttling incoming requests based on the server system capacity, the predicted number of incoming requests, the distribution of historical prioritization values, and the prioritization value of a received request. Server systems can incur costs while processing requests. For example, when a server device receives a request for content, the server device may incur costs in processing the request. The costs can be determined based on the infrastructure (e.g., CPUs, memory, disk) required to process the request. When the number of incoming requests exceeds a number of requests the server system's available capacity is able to process, it may be advantageous to drop the requests having lower prioritization values and process only the requests having higher prioritization values. By throttling the incoming requests that have lower prioritization values when the server system has reduced capacity, the systems and methods described herein can be used to optimize the utilization of the server system.

In some implementations, a data processing system can determine a predicted number of incoming requests that may occur in the next time period (e.g., 1 second). The data processing system can also determine a current available capacity of the data processing system for processing the incoming requests. For example, the current available capacity can be determined based on the memory capacity, the disk capacity, and the processor capacity of the data processing system. The data processing system can compare the predicted number of incoming requests with the current available capacity of the data processing system to determine if the data processing system is sufficient to process the predicted number of incoming requests.

In the event that the data processing system determines that the data processing system does not have enough available capacity to process the predicted number of incoming requests, the data processing system determines whether a received request should be dropped or should be processed. In some implementations, the data processing system can assign a prioritization value to the received request based on attributes associated with the computing device according to a prioritization policy. For example, if the attributes associated with the computing device from which the request is received indicates that the request is latency sensitive (e.g., near the end of an online game when the scores of the two sides are close), the data processing system may assign a higher prioritization value to the request. On the other hand, if the request is less latency sensitive (e.g., at the beginning of an online game), the data processing system may assign a lower prioritization value to the request. The prioritization value can also be assigned based on the geographic location of the computing device sending the request, the IP address of the computing device sending the request, performance metrics associated with the computing device, etc.

The data processing system also determines a throttling threshold value based on the current available capacity of the data processing system, the predicted number of incoming requests, and a distribution of historical prioritization values of prior requests. The data processing system compares the prioritization value assigned to the received request with the determined throttling threshold value. If the prioritization value is below the determined throttling threshold value, the received request is throttled and not processed. If the prioritization value is at or above the determined throttling threshold value, the received request is processed.

It should be appreciated that there are many applications of this disclosure. For instance, the systems and methods described herein can be used to reduce the adverse effects resulting from an attack on a server, such as a Denial of Service attack by throttling requests associated with a bad actor perpetrating the attack.

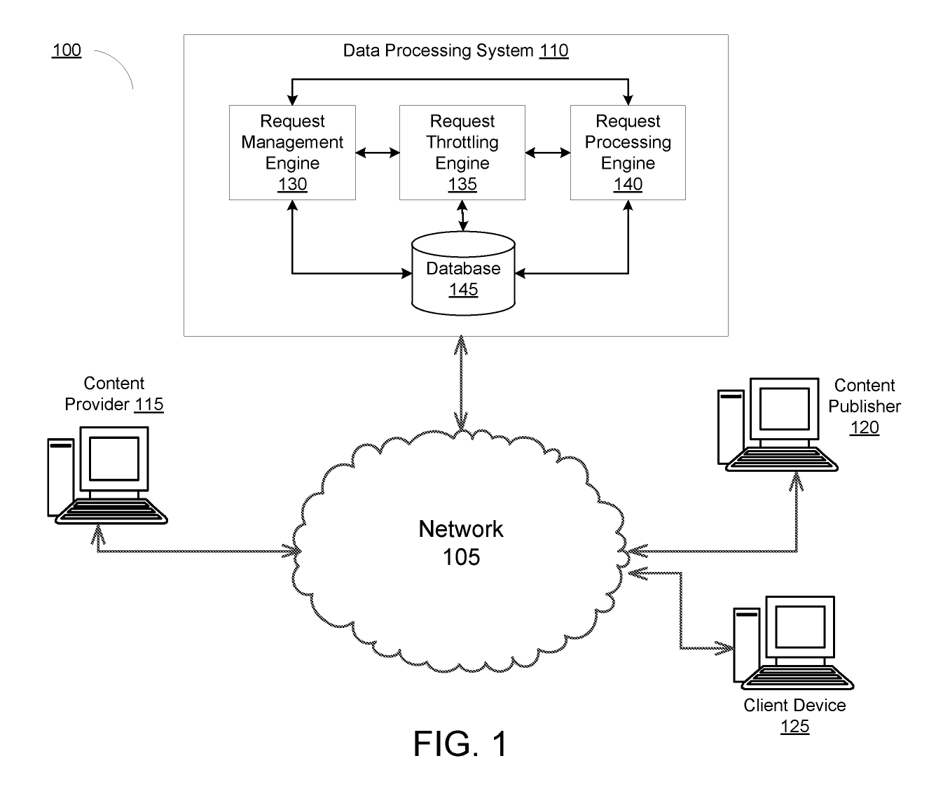

FIG. 1 is a block diagram depicting one implementation of a system 100 for throttling incoming network traffic requests, according to an illustrative implementation. The environment 100 includes at least one data processing system 110. The data processing system 110 can include at least one processor (or a processing circuit) and a memory. The memory stores processor-executable instructions that, when executed on the processor, cause the processor to perform one or more of the operations described herein. The processor can include a microprocessor, application-specific integrated circuit (ASIC), field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions can include code from any suitable computer-programming language. The data processing system 110 can include one or more computing devices or servers that can perform various functions.

The network 105 can include computer networks such as the internet, local, wide, metro or other area networks, intranets, satellite networks, other computer networks such as voice or data mobile phone communication networks, and combinations thereof. The data processing system 110 of the environment 100 can communicate via the network 105, for instance with at least one content provider computing device 115, at least one content publisher computing device 120, or at least one client device 125. The network 105 may be any form of computer network that relays information between the client device 125, data processing system 110, and one or more content sources, for example, web servers, content servers, amongst others. For example, the network 105 may include the Internet and/or other types of data networks, such as a local area network (LAN), a wide area network (WAN), a cellular network, satellite network, or other types of data networks. The network 105 can also include any number of computing devices (e.g., computer, servers, routers, network switches, etc.) that are configured to receive and/or transmit data within network 105. The network 105 can further include any number of hardwired and/or wireless connections. For example, the client device 125 can communicate wirelessly (e.g., via WiFi, cellular, radio, etc.) with a transceiver that is hardwired (e.g., via a fiber optic cable, a CAT5 cable, etc.) to other computing devices in network 105.

The content provider computing device 115 can include servers or other computing devices operated by a content provider entity to provide one or more content items for display on information resources at the client device 125. The content provided by the content provider computing device 115 can include third-party content items for display on information resources, such as a website or web page that includes primary content, e.g., content provided by the content publisher computing device 120. The content items can also be displayed on a search results web page. For instance, the content provider computing device 115 can provide or be the source of one or more content items for display in content slots of content web pages, such as a web page of a company where the primary content of the web page is provided by the company, or for display on a search results landing page provided by a search engine. The content items associated with the content provider computing device 115 can be displayed on information resources other than web pages, such as content displayed as part of the execution of an application (such as a global positioning system (GPS) or map application, or other types of applications) on a smartphone or other client device 125. The content provider computing device 115 can also provide other types of content. For example, the content provider computing device 115 can provide online game content.

The content publisher computing device 120 can include servers or other computing devices operated by a content publishing entity to provide primary content for display via the network 105. For instance, the content publisher computing device 120 can include a web page operator who provides primary content for display on the web page. The primary content can include content other than that provided by the content publisher computing device 120, and the web page can include content slots configured for the display of third party content items from the content provider computing device 115. For instance, the content publisher computing device 120 can operate the website of a company and can provide content about that company for display on web pages of the website. The web pages can include content slots configured for the display of third-party content items of the content provider computing device 115. In some implementations, the content publisher computing device 120 includes a search engine computing device (e.g. server) of a search engine operator that operates a search engine website. The primary content of search engine web pages (e.g., a results or landing web page) can include results of a search as well as third party content items displayed in content slots such as content items from the content provider computing device 115. In some implementations, the content publisher computing device 120 can include a server for serving video content. For example, the content publisher computing device 120 can serve online game content.

The client device 125 can include computing devices configured to communicate via the network 105 to display data such as the content provided by the content publisher computing device 120, the content provider computing device 115, or the data processing system 110. The client device 125, the content provider computing device 115, and the content publisher computing device 120 can include desktop computers, laptop computers, tablet computers, smartphones, personal digital assistants, mobile devices, consumer computing devices, servers, clients, digital video recorders, a set-top box for a television, a video game console, or any other computing device configured to communicate via the network 105. The client device 125 can be communication devices through which an end-user can submit requests to receive content. The requests can be requests to a search engine and the requests can include search queries. In some implementations, the requests can include a request to access a web page. In some implementations, the requests can be requests for online game or other content.

The content provider computing device 115, the content publisher computing device 120 and the client device 125 can include a processor and a memory, i.e., a processing circuit. The memory stores machine instructions that, when executed on the processor, cause the processor to perform one or more of the operations described herein. The processor can include a microprocessor, application-specific integrated circuit (ASIC), field-programmable gate array (FPGA), etc., or combinations thereof. The memory can include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions can include code from any suitable computer-programming language.

The content provider computing device 115, the content publisher computing device 120, and the client device 125 can also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices can be internal to a housing of the content provider computing device 115, the content publisher computing device 120 and the client device 125 (e.g., a built-in display, microphone, etc.) or external to the housing of content provider computing device 115, the content publisher computing device 120 and the client device 125 (e.g., a monitor connected to the user computing device 115, a speaker connected to the client device 125, etc.), according to various implementations. For example, the content provider computing device 115, the content publisher computing device 120 and the client device 125 can include an electronic display, which visually displays web pages using webpage data received from one or more content sources and/or from the data processing system 110 via the network 105.

The data processing system 110 can include at least one server. For instance, the data processing system 110 can include a plurality of servers located in at least one data center or server farm. In some implementations, the data processing system 110 can include a third-party content placement system, e.g., a content server. The data processing system 110 can include at least one request management engine 130, at least one request throttling engine 135, at least one request processing engine 140, and at least one database 145. The request management engine 130, the request throttling engine 135 and the request processing engine 140 each can include at least one processing unit, server, virtual server, circuit, engine, agent, appliance, or other logic device such as programmable logic arrays configured to communicate with the database 145 and with other computing devices (e.g., the content provider computing device 115, the content publisher computing device 120, or the client device 125) via the network 105.

The request management engine 130, the request throttling engine 135 and the request processing engine 140 can include or execute at least one computer program or at least one script. The request management engine 130, the request throttling engine 135 and the request processing engine 140 can be separate components, a single component, or part of the data processing system 110. The request management engine 130, the request throttling engine 135 and the request processing engine 140 can include combinations of software and hardware, such as one or more processors configured to execute one or more scripts.

The data processing system 110 can also include one or more content repositories or databases 145. The databases 145 can be local to the data processing system 110. In some implementations, the databases 145 can be remote to the data processing system 110 but can communicate with the data processing system 110 via the network 105. The databases 145 can store web pages, portions of webpages, third-party content items, and online games, among others, to serve to a client device 125.

The request management engine 130 can receive a request from the client device 125. The request can be a request for content. The request for content can include a request for one or more third-party content items or other content for display at the client device. In some implementations, the request for content can include an address or identifier of an information resource on which the requested content is to be displayed. The request for content can also include or identify one or more parameters that can be used by the data processing system 110 to determine the content to provide in response to the request for content. For example, the parameters can identify a size of a content slot within which to insert the requested content. The parameters can identify a type of content associated with the information resource, a type of content requested (e.g., text, image, video, etc.), client device information, size information for the requested content item or a combination thereof. In some implementations, the request for content can include a request for an information resource. The request for an information resource can include an address or identifier of the information resource. For example, the request for the information resource can include a URL of a specific resource such as a webpage (e.g., “http://www.example.com”). The request for information resource can also include client device information (such as a device type, device identifier or a combination thereof). As described herein below, the requests can be of different request types. For example, the requests can include video content requests, audio content requests, text content requests, etc.

The request throttling engine 135 can be configured to determine whether to throttle a request in response to receiving the request from the request management engine 130. The determination can be based on various factors, for example, server system capacity, predicted number of incoming requests, distribution of historical prioritization values, and a prioritization value of the received request. If the request throttling engine 135 determines that a received request should not be throttled, the request throttling engine 135 can pass the request to the request processing engine 140 for processing. The request processing engine 140, upon processing the request, may either transmit the requested content to the client device 125 or provide the requested content to the request management engine 130 for the request management engine 130 to transmit the requested content to the client device 125.

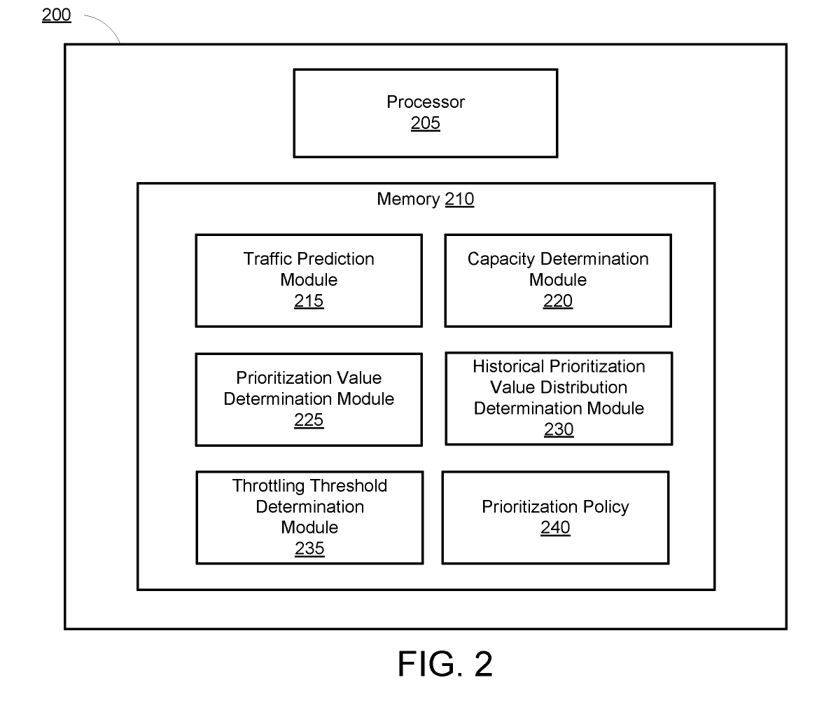

On the other hand, if the request throttling engine 135 determines that a received request should be throttled, the request throttling engine 135 does not pass the request to the request processing engine 140 for processing and informs the request management engine 130 that the request is not being processed. Depending on various implementations, the request management engine 130 may provide a message to the client device 125 to inform the client device 125 that the request is not being processed, or may provide a placeholder item to the client device 125 in place of the content that is requested, or may not provide any response to the client device 125. One embodiment of the request throttling engine 135 is described further herein below in relation to FIG. 2.

The request processing engine 140 can be configured to determine content to be transmitted to the client device 125 in response to receiving the request from the request throttling engine 135. The request processing engine 140 can determine the content to be sent to the client device 125 based on information included in the request for content. For instance, upon receiving a request for an information resource, the request processing engine 140 can use the address or identifier of the information resource in the request to determine the content to send to the client device. In the case of receiving a request for content items, the request processing engine 140 can select the content item(s) based on an address or identifier for the information resource on which the content item is to be presented, content type information (e.g., sports, news, music, movies, travel, etc.) for the information resource, size information of the slot(s) in which the content item(s) is/are to be displayed, client device information (e.g., device type, device identifier, device location, etc.). In some implementations, the request processing engine 140 can access the database 145 and retrieve the content for sending to the client device 125.

In some implementations, the data processing system 110 can receive a request from a client device 125 via a computer network 105. For example, the request management engine 130 can be configured to receive the request. The request can be a request for information resources, third-party content items, online game content, or other content. In some implementations, the request can include attributes associated with the client device 125, such as a device identifier of the client device 125, a HyperText Transfer Protocol (HTTP) cookie which may contain an anonymized device identifier (e.g., a number) which can represent the user of the client device 125, uniform resource locator (URL) of the web page accessed by the client device 125, location of the client device 125 (e.g., an internet protocol (IP) address of the client device 125), device type of the client device 125, current status of the client device 125, current status of one or more applications opened/executed on the client device 125, one or more browser types of one or more browsers used by the client device 125, etc.

In some implementations, the data processing system 110 can determine whether to process or throttle the received request. In some implementations, the request management engine 130 can transmit the received request to the request throttling engine 135 to determine whether to process or throttle the received request.

FIG. 2 is a block diagram depicting one implementation of a request throttling engine 200, according to an illustrative implementation. The request throttling engine 200 can be a separate server or computing device of the data processing system 110 or can be part of a server or computing device that also includes the request management engine 130 and/or the request processing engine 140. In some implementations, the request throttling engine 200 can be a server or computing device outside of the data processing system 110. The request throttling engine 200 can include a processor 205 and a memory 210 similar to the processor and memory described herein above in relation to FIG. 1.

In some implementations, the memory 210 can include or store a traffic prediction module 215, a capacity determination module 220, a prioritization value determination module 225, a historical prioritization value distribution determination module 230 (referred to herein as distribution determination module 230), a throttling threshold determination module 235, and a prioritization policy 240. In some implementations, the processor 205 can execute the modules 215-235 to perform operations as described herein. In some implementations, the modules 215-235 can be implemented as one or more special purpose hardware circuits for performing the operations as described herein.

In some implementations, the traffic prediction module 215 can be configured to determine a predicted number of incoming requests for a first time period. The first (or next) time period can be the next one second, the next one minute, or any other time period in the immediate near future. In some implementations, the time period can be any predetermined length of time. In some implementations, the traffic prediction module 215 can determine the number of incoming requests for the next time period based on past distribution of traffic load during similar times in the previous time periods. The previous time periods can correspond to previous seconds, minutes, hours, days, months, or years. In some implementations, the data processing system 110 can maintain a log of requests received during the past month, past year, or past several years in the database 145. The traffic prediction module 215 can analyze the log to predict the number of incoming requests. For example, the traffic prediction module 215 can predict the number of incoming requests for the next second based on the number of requests received in a previous time period, such as the previous second, the previous minute, the previous hour, the same time yesterday, the same time of the same day of week in last week, the same time of the same day in last year or any combination thereof. In some implementations, the traffic prediction module 215 may assign weight to each previous time period when a combination of previous time period is used. For example, the traffic prediction module 215 may assign more weight to the previous second than the same time of the same day last year.

In some implementations, the traffic prediction module 215 can predict the number of incoming requests based on current events. For example, the data processing system 110 can maintain a calendar of events in the database 145. The events can be events occurring on a periodical basis or can be one-time important events. For example, if the calendar indicates that there is a major sporting event today, the traffic prediction module 215 may retrieve past traffic load data during the same major sporting event occurred in the past from the database 145 and determine the number of incoming requests based on the retrieved data. In some implementations, the number of incoming requests for the next time period can be determined based on network condition, traffic congestion, network equipment, etc. For example, if the traffic prediction module 215 receives notification of network fault, the traffic prediction module 215 can predict a relatively lower number of incoming requests than when there is no network fault.

In some implementations, the traffic prediction module 215 can predict request types of the incoming requests. For example, for the incoming requests for the next second, the traffic prediction module 215 can predict that fifty percent of the requests are for text content, forty percent of the requests are for video content, and the rest are for audio content. In some implementations, the traffic prediction module 215 can predict request types of the incoming requests based on past distribution of traffic load during similar times in the previous time periods or based on current events, similar to the manner that the traffic prediction module 215 predicts the number of incoming requests.

In some implementations, the capacity determination module 220 can be configured to determine a current available capacity of the data processing system 110 for processing incoming requests. The capacity determination module 220 can determine the current available capacity of the data processing system 110 based on a memory capacity, a disk capacity, and a processor or central processing unit (CPU) capacity of the data processing system. For example, the capacity determination module 220 can identify a list of computing devices, including servers and storage devices, in the data processing system 110 for processing incoming requests and determine available capacities of those computing devices. In some implementations, the database 145 can maintain information of the characteristics of the computing devices in the data processing system 110. For example, the database 145 can store a computing device's device type, CPU size, memory size, disk size, utilization percentage, etc. In some implementations, the capacity determination module 220 can obtain characteristics of the computing devices, such as CPU clock speed, RAM size, RAM utilization, etc. directly from the computing devices. The capacity determination module 220 can calculate the total current available capacity of those computing devices in the list based on the obtained characteristics information of the list of computing devices. In some implementations, the capacity determination module 220 can quantify the computing device capacity in a standard unit or a self-defined unit (e.g., defined by the capacity determination module 220 or the data processing system 110). For illustration purposes only, this disclosure uses a self-defined unit “resource unit” (RU) as the unit for measuring computing device capacity. For example, the capacity determination module 220 may define one kilobyte (KB) of memory size as one resource unit. Other self-defined unit or standard unit can be used. In some implementations, the capacity determination module 220 can determine the current available capacity of the data processing system 110 by summing up the capacity of each computing device in the list of computing devices in the data processing system 110 for processing the incoming requests.

In some implementations, the request throttling engine 200 can determine whether the current available capacity of the data processing system 110 is sufficient to process the predicted number of incoming requests. For example, the traffic prediction module 215 or the capacity determination module 220 can be configured to determine whether the current available capacity of the data processing system 110 is sufficient to process the predicted number of incoming requests. In some implementations, the request throttling engine 200 can assign a resource utilization value to each predicted incoming request. The resource utilization value of a request can be the amount of computing device capacity (e.g., expressed in terms of RU) usually used by the data processing system 110 to process the request. As described herein above, in some implementations, the traffic prediction module 215 can predict request types of the incoming requests. Thus, in some implementations, the request throttling engine 200 can assign a resource utilization value to a request based on the request type of request. For example, the request throttling engine 200 can assign a predetermined number of the resource utilization value (for example, X RU) to a request for text content, and assign three times of the predetermined number of the resource utilization value (for example, 3X RU) to a request for video content. It should be understood that the “X” here can be any number and the 3X here (i.e., 3 times of X) is just an example for illustration purpose only. In some implementations, the request throttling engine 200 can assign an average resource utilization value to each predicted incoming request regardless of the request type of the request. In some implementations, the request throttling engine 200 can determine the total resource utilization value for the number of incoming requests for the next time period that is predicted by the traffic prediction module 215. For example, the request throttling engine 200 can determine the total resource utilization value of the predicted incoming requests by summing up the resource utilization value of each predicted request.

In some implementations, the request throttling engine 200 can compare the total resource utilization value of the predicted incoming requests in the next time period with the determined current available capacity of the data processing system 110 for processing the requests. In some implementations, the request throttling engine 200 can determine that the current available capacity of the data processing system 110 is sufficient to process the predicted number of incoming requests for the next time period if the total resource utilization value of the predicted incoming requests in the next time period is less than or equal to the current available capacity of the data processing system 110 for processing the requests. Conversely, the request throttling engine 200 can determine that the current available capacity of the data processing system 110 is insufficient to process the predicted number of incoming requests for the next time period if the total resource utilization value of the predicted incoming requests in the next time period is greater than the current available capacity of the data processing system 110 for processing the requests.

In some implementations, the request throttling engine 200 can determine that the current available capacity of the data processing system 110 is sufficient to process the predicted number of incoming requests for the next time period by determining that the difference between the total resource utilization value of the predicted incoming requests in the next time period and the current available capacity of the data processing system for processing the requests is less than or equal to a predetermined error value. Stated in another way, the request throttling engine 200 or the data processing system 110 can determine that the current available capacity of the data processing system 110 is sufficient to process the predicted number of incoming requests for the next time period if: R−C<=E, where R is the total resource utilization value of the predicted incoming requests in the next time period, C is the current available capacity of the data processing system 110 for processing the requests, and E is a predetermined error. Conversely, the data processing system 110 can determine that the current available capacity of the data processing system 110 is insufficient to process the predicted number of incoming requests for the next time period if the difference between the total resource utilization value of the predicted incoming requests in the next time period and the current available capacity of the data processing system for processing the requests is greater than a predetermined error value. Stated differently, if the request throttling engine 200 or the data processing system 110 determines that R−C>E, the request throttling engine 200 can determine that the current available capacity of the data processing system 110 is insufficient to process the predicted number of incoming requests for the next time period. In some implementations, the request throttling engine 200 can determine the predetermined error E based on historical values, trial and error, etc. In some implementations, the predetermined error E can be a multiple of the resource unit, for instance, 100 RU, 20 RU, 1 RU, 0 RU, −2 RU, etc.

In some implementations, the request throttling engine 200 determines that the current available capacity of the data processing system 110 is insufficient to process the predicted number of incoming requests for the next time period. Responsive to such a determination, the prioritization value determination module 225, using a prioritization policy 240, can assign or predict a prioritization value to the request based on one or more attributes associated with the client device 125 from which the request was received. As described herein above, in some implementations, the request received from the client device 125 can include one or more attributes associated with the client device 125. For example, the attributes associated with the client device 125 can include a device identifier of the client device 125, a HTTP cookie which may contain an anonymized device identifier (e.g., a number) which can represent the user of the client device 125, uniform resource locator (URL) of the web page accessed by the client device 125, location of the client device 125 (e.g., an internet protocol (IP) address of the client device 125), device type of the client device 125, current status of the client device 125, current status of one or more applications opened/executed on the client device 125, one or more browser types of one or more browsers used by the client device 125, etc.

In some implementations, the prioritization policy 240 can include a set of rules for assigning or predicting prioritization values to the request based on the one or more attributes associated with the client device 125 from which the request was received. In some implementations, the prioritization policy 240 can include one or more latency prioritization rules specifying a set of latency sensitivity levels. For example, the set of latency sensitivity levels can range from a first level to a nth level, with the first level being the lowest latency sensitivity level and the nth level being the highest latency sensitivity level. In one example, the first level can be level 1 and the nth level can be level 10. It should be understood that the examples of the latency sensitivity levels described in this disclosure are for illustration purpose only, and the latency sensitivity levels can be represented in various other forms and scales.

In some implementations, the prioritization policy 240 can determine the latency sensitivity level of a request based on the one or more attributes associated with the client device 125. For example, the request can include the current status of an online game application executed on the client device 125. If the current status of the online game application indicates that the currently playing game is at a close stage (e.g., near the end of the online game when the scores of the two sides are close), the prioritization value determination module 225 may assign a higher latency sensitivity level (e.g., a level 9 when the range is, for example, 1-10) to the request. On the other hand, if the current status of the online game application indicates that the online game is at the beginning of the game or the scores of the two sides are not close, the prioritization value determination module 225 may assign a lower latency sensitivity level (e.g., a level 2 when the range is, for example, 1-10) to the request.

In some implementations, the prioritization value determination module 225 can assign a prioritization value to the request based on the determined latency sensitivity level of the request. In some implementations, the prioritization values can range from a first value to a nth value (e.g., 1 to 10, or 1 to 100, or other ranges). In other implementations, the prioritization values can be represented in various other forms (e.g., percentages, e.g., 1% to 100%, etc.). It should be understood that the examples of the prioritization values described in this disclosure are for illustration purpose only, and the prioritization values can be represented in various other forms and scales. In some implementations, the prioritization value determination module 225 can assign to the request a prioritization value that is proportional to the determined latency sensitivity level. For example, the prioritization value determination module 225 can assign to the request a prioritization value of 90 (when the exemplary scale is 1-100) if the determined latency sensitivity level is 9 (when the exemplary scale 1-10).

In some implementations, the prioritization policy 240 can include one or more geographic location prioritization rules for assigning prioritization values based on geographic locations. In some implementations, the prioritization value determination module 225 can determine the geographic location of the client device 125 based on one or more attributes associated with the client device 125, for example an Internet Protocol (IP) address of the client device 125, a device identifier of the client device 125, a HTTP cookie associated with the client device 125, or information (e.g., login information) provided by the user of the client device 125. In some implementations, if the prioritization value determination module 225 determines that a request is received from a client device 125 located at a geographic location from where a number of other requests have also been received within a certain time period, the prioritization value determination module 225 may assign a lower prioritization value (e.g., a value of 1 in a range 1-100) to the request. In such a case, the request may be identified as part of a Denial of Service attack. By assigning a lower prioritization value to the request, adverse effects resulting from such an attack on the data processing system 110 can be reduced.

In some implementations, the prioritization policy 240 can include one or more performance prioritization rules for assigning prioritization values based on one or more performance metrics associated with the client device 125. In some implementations, the prioritization value determination module 225 can obtain the performance metrics associated with the client device 125 by searching the database 145 using the one or more attributes associated with the client device 125. For example, the prioritization value determination module 225 can use a device identifier and/or an identifier in a HTTP cookie received along with the request to search the database 145. In some implementations, the database 145 can store performance metrics of an action performed by the client device 125 or a user identifier associated with the client device 125. For example, the action can be signing up a membership, clicking on a content item displayed on a web page at the client device 125, or purchasing a product on a web page displayed at the client device 125, etc. In some implementations, the performance metrics can include a click rate or a conversion rate indicating the likelihood that the user identifier at the client device 125 may click on a content item or take an action with respect to a content item. In some implementations, the performance metrics retrieved from the database 145 can indicate whether the client device 125 performs an action successfully or unsuccessfully. In some implementations, the performance metrics can include a score indicating how well the client device 125 performed the action. In some implementations, the prioritization value determination module 225 can assign a prioritization value to the request based on the performance metrics. For example, the prioritization value determination module 225 can assign to the request a prioritization value (e.g., a value of 90 when the exemplary scale is 1-100) that is proportional to the performance metrics (e.g., a score of 9 when the exemplary score is 1-10) to the request.

In some implementations, the prioritization value determination module 225 can utilize one or more machine learning models to determine the prioritization value of the received request. In some implementations, the prioritization value determination module 225 can store the predicted prioritization values of requests over time, determine and store actual values of the requests, identify correlations between the predicted prioritization values and the actual values, identify features indicating characteristics and patterns of the requests, and adjust processes of predicting the prioritization values.

In some implementations, the distribution determination module 230 can determine a distribution of historical prioritization values corresponding to a second time period. For example, the distribution determination module 230 can record historical prioritization values in the day before (or last week, last month, last hour, etc.) and store the recorded historical prioritization values to the database 145. In some implementations, the second time period corresponding to the distribution can have the same length as the first time period with which the predicted number of incoming request was determined, as described herein above. In some implementations, the second time period corresponding to the distribution can be a different time length as the first time period with which the predicted number of incoming request was determined. In some implementations, rather than recording historical prioritization values within a time period, the distribution determination module 230 can record historical prioritization values up to a finite number of historical requests. For example, the distribution determination module 230 can record historical prioritization values up to 1,000 requests, 10,000 requests, 100,000 requests, 1 million requests, etc. In some implementations, the predicted values may be used as a proxy for the actual values. For instance, in some situations, the actual prioritization values cannot be determined at least for some requests. For example, the requests that were throttled cannot not have actual prioritization values because they are not processed. Thus, in some implementations, the distribution determination module 230 may use predicted values for generating the distribution. In some implementation, the distribution determination module 230 may use actual values for generating the distribution. In some implementations, the distribution determination module 230 may use a combination of predicted values and actual values for generating the distribution. In some implementations, the distribution determination module 230 can create a distribution of the recorded historical prioritization values, which can be used to determine a throttling threshold value as described herein below. For example, the distribution determination module 230 can create a distribution of the historical prioritization values corresponding to the second time period by arranging the historical prioritization values in the order from the lowest prioritization value to the highest prioritization value. Thus, the request throttling engine 200 can quickly determine, for example, which prioritization value is at 10% of the distribution, at 50% of the distribution, at 80% of the distribution, etc.

In some implementations, responsive to determining that the current available capacity of the data processing system 110 is insufficient to process the predicted number of incoming requests, the throttling threshold determination module 235 determines a throttling threshold value. The throttling threshold value can be determined based on the current available capacity of the data processing system 110, the predicted number of incoming requests for the first time period, and the distribution of historical prioritization values. The distribution of historical prioritization values can correspond to a time period or can correspond to a finite number of historical requests, as described herein above. In some implementations, the throttling threshold determination module 235 can determine how many of the predicted number of incoming requests are to be throttled based on the current available capacity of the data processing system 110. For example, the throttling threshold determination module 235 can determine that half of the predicted number of incoming requests in the next time period should be throttled if the total resource utilization value of the predicted incoming requests in the next time period is twice the current available capacity of the data processing system 110. Continuing with this example, the throttling threshold determination module 235 can use a distribution of historical prioritization values created by the distribution determination module 230 to locate the prioritization value which is at 50% of the distribution (e.g., approximately half of the historical prioritization values in the distribution is below this prioritization value). In this example, the throttling threshold determination module 235 can determine that the prioritization value at 50% of the distribution as the throttling threshold value. In some implementations, the throttling threshold determination module 235 can retrieve the distribution of historical prioritization values from the database 145. In some implementations, the throttling threshold determination module 235 can request the throttling threshold determination module 235 to generate the distribution of historical prioritization values dynamically.

In some implementations, the throttling threshold determination module 235 can determine the throttling threshold value based on a distribution of historical prioritization values and one or more prior throttling threshold values determined using the distribution of historical prioritization values. Continuing with the above example, the prior throttling threshold value determined using the distribution of historical prioritization values is 65 (e.g., the range of the prioritization values is 1-100). In this example, the predicted number of incoming requests in the next time period is 2000. Using the throttling threshold value of 65, the request throttle engine 200 may expect that approximately 1000 incoming requests (out of 2000 predicted number of incoming requests in the time period) are throttled. However, in this example, it turns out that 1500 incoming requests are actually throttled, indicating that the throttling threshold value of 65 is higher than it should be. Based on this information, when determining the next throttling threshold value using the distribution of historical prioritization values, the throttling threshold determination module 235 may adjust the throttling threshold value accordingly (e.g., adjusting the throttling threshold value to a value of less than 65). In some implementations, the throttling threshold determination module 235 may adjust the throttling threshold value several times until finding a throttling threshold value that can generally throttle the number of incoming requests as expected or intended.

In some implementations, the request throttling engine 200 determines whether the prioritization value assigned to the request is below the determined throttling threshold value. If the request throttling engine 200 determines that the prioritization value assigned to the request is below the determined throttling threshold value, the request throttling engine 200 throttles the request. In some implementations, responsive to determining that the prioritization value assigned to the request is below the throttling threshold, the data processing system 110 skips processing the request. For example, the request throttling engine 200 does not pass the request to the request processing engine 140 and thus the request is not processed by request processing engine 140. In some implementations, the request throttling engine 200 determines that the prioritization value assigned to the request is not below (e.g., at or above) the determined throttling threshold value. Responsive to such a determination, the data processing system 110 processes the request by passing the request from the request throttling engine 200 to the request processing engine 140 for processing.

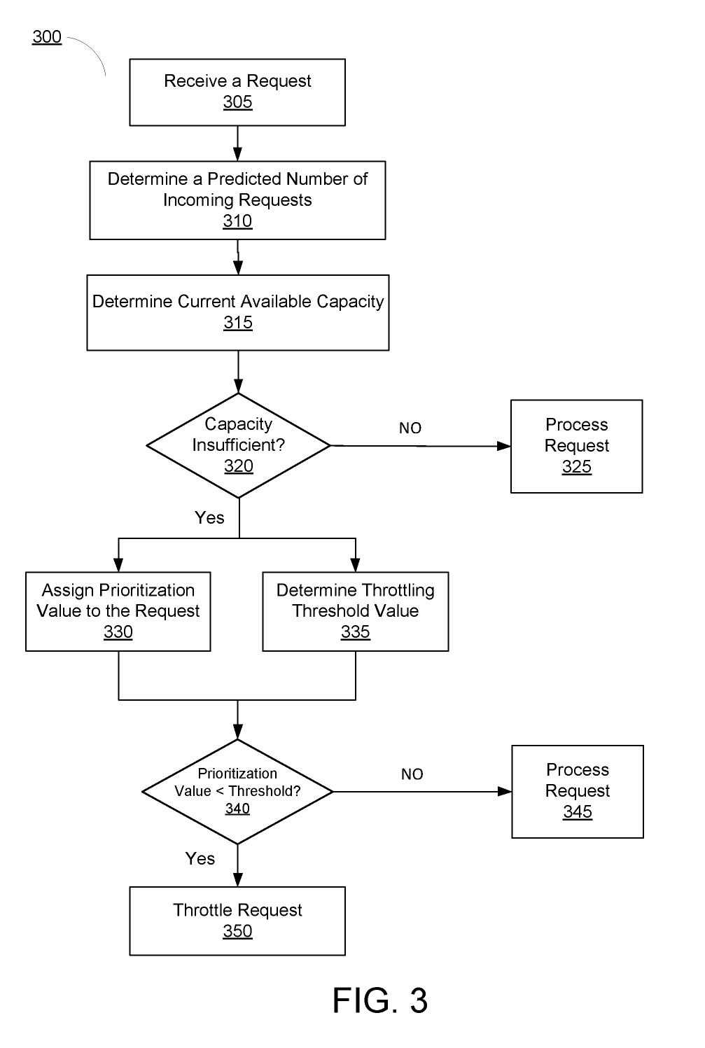

FIG. 3 is a flow diagram depicting a method 300 of throttling incoming network traffic requests, according to an illustrative implementation. In brief overview, the method 300 can include a data processing system receiving a request from a computing device via a computer network (BLOCK 305) and the request comprises one or more attributes associated with the computing device. The method 300 can include the data processing system determining a predicted number of incoming requests for a first time period (BLOCK 310). The method 300 can include the data processing system determining a current available capacity of the data processing system for processing incoming requests (BLOCK 315). The method 300 can include the data processing system determining whether the current available capacity of the data processing system is insufficient to process the predicted number of incoming requests (BLOCK 320). The method 300 can include, responsive to determining that the current available capacity of the data processing system is sufficient to process the predicted number of incoming requests, the data processing system processing the request (BLOCK 325), and responsive to determining that the current available capacity of the data processing system is insufficient to process the predicted number of incoming requests, the data processing system assigning, using a prioritization policy, a prioritization value to the request based on the one or more attributes associated with the computing device (BLOCK 330) and determining a throttling threshold value based on the current available capacity of the data processing system, the predicted number of incoming requests for the first time period, and a distribution of historical prioritization values corresponding to a second time period (BLOCK 335). The method 300 can include the data processing system determining whether the prioritization value assigned to the request is below the determined throttling threshold value (BLOCK 340). The method 300 can include, responsive to determining that the prioritization value assigned to the request is not below the determined throttling threshold value, the data processing system processing the request (BLOCK 345), and responsive to determining that the prioritization value assigned to the request is below the determined throttling threshold value, the data processing system throttling the request (BLOCK 350).

In further detail, the method 300 can include the data processing system receiving a request from a computing device via a computer network (BLOCK 305). The request can include one or more attributes associated with the computing device. The request can be a request for information resources, third-party content items, online game content, or other content. In some implementations, the attributes associated with the client device 125 can include a device identifier of the client device 125, a HTTP cookie which may contain an anonymized device identifier (e.g., a number) which can represent the user of the client device 125, uniform resource locator (URL) of the web page accessed by the client device 125, location of the client device 125 (e.g., an internet protocol (IP) address of the client device 125), device type of the client device 125, current status of the client device 125, current status of one or more applications opened/executed on the client device 125, one or more browser types of one or more browsers used by the client device 125, etc.

The method 300 can include the data processing system determining a predicted number of incoming requests for a first time period (BLOCK 310). The first (or next) time period can be the next one second, the next one minute, or any other time period in the immediate near future. In some implementations, the time period can be any predetermined length of time. In some implementations, the data processing system can determine the number of incoming requests for the next time period based on past distribution of traffic load during similar times in the previous time periods. The previous time periods can correspond to previous seconds, minutes, hours, days, months, or years. In some implementations, the data processing system can maintain a log of requests received during the past month, past year, or past several years in a database. The data processing system can analyze the log to predict the number of incoming requests. For example, the data processing system can predict the number of incoming requests for the next second based on the number of requests received in a previous time period, such as the previous second, the previous minute, the previous hour, the same time yesterday, the same time of the same day of week in last week, the same time of the same day in last year or any combination thereof. In some implementations, the data processing system may assign weight to each previous time period when a combination of previous time period is used. For example, the data processing system may assign more weight to the previous second than the same time of the same day in last year.

In some implementations, the data processing system can predict the number of incoming requests based on current events. For example, the data processing system can maintain a calendar of events in the database. The events can be events occurring on a periodical basis or can be one-time important events. For example, if the calendar indicates that there is a major sporting event today, the data processing system may retrieve past traffic load data during the same major sporting event occurred in the past from the database and determine the number of incoming requests based on the retrieved data. In some implementations, the number of incoming requests for the next time period can be determined based on network condition, traffic congestion, network equipment, etc. For example, if the data processing system receives notification of network fault, the data processing system can predict a lower number of incoming requests than when there is no network fault. In some implementations, the data processing system can predict request types of the incoming requests. For example, for the incoming requests for the next second, the data processing system can predict that fifty percent of the requests are for text content, forty percent of the requests are for video content, and the rest are for audio content. In some implementations, the data processing system can predict request types of the incoming requests based on past distribution of traffic load during similar times in the previous time periods or based on current events.

The method 300 can include the data processing system determining a current available capacity of the data processing system for processing incoming requests (BLOCK 315). In some implementations, the data processing system can determine the current available capacity based on a memory capacity, a disk capacity, and a processor or central processing unit (CPU) capacity. For example, the data processing system can identify a list of computing devices, including servers and storage devices, in the data processing system for processing incoming requests and determine available capacities of those computing devices. In some implementations, the database can maintain information of the characteristics of the computing devices in the data processing system. For example, the database can store a computing device's device type, CPU size, memory size, disk size, utilization percentage, etc. In some implementations, the data processing system can obtain characteristics of the computing devices, such as CPU clock speed, RAM size, RAM utilization, etc. directly from the computing devices. The data processing system can calculate the total current available capacity of those computing devices in the list based on the obtained characteristics information of the list of computing devices. In some implementations, the data processing system can quantify the computing device capacity in a standard unit or a self-defined unit (e.g., defined by data processing system). For example, the data processing system can use a self-defined unit “resource unit” (RU) as the unit for measuring computing device capacity. For example, the data processing system may define one kilobyte (KB) of memory size as one resource unit. Other self-defined unit or standard unit can be used. In some implementations, the data processing system can determine the current available capacity of the data processing system by summing up the capacity of each computing device in the list of computing devices in the data processing system for processing the incoming requests.

The method 300 can include the data processing system determining whether the current available capacity of the data processing system is insufficient to process the predicted number of incoming requests (BLOCK 320), and responsive to determining that the current available capacity of the data processing system is sufficient to process the predicted number of incoming requests, the data processing system processing the request (BLOCK 325).

In some implementations, data processing system can assign a resource utilization value to each predicted incoming request. The resource utilization value of a request can be the amount of computing device capacity (e.g., expressed in terms of RU) usually used by the data processing system to process the request. In some implementations, the data processing system can assign a resource utilization value to a request based on the request type of request. For example, the data processing system can assign a predetermined number of the resource utilization value (for example, X RU) to a request for text content, and assign three times the predetermined number of resource utilization value (for example, 3X RU) to a request for video content. It should be understood that the “X” here can be any number and the 3X here (i.e., 3 times of X) is just an example for illustration purpose only. In some implementations, the data processing system can assign an average resource utilization value to each predicted incoming request regardless of the request type of the request. In some implementations, the data processing system can determine the total resource utilization value for the number of incoming requests for the next time period. For example, the data processing system can determine the total resource utilization value of the predicted incoming requests by summing up the resource utilization value of each predicted request.

In some implementations, the data processing system can compare the total resource utilization value of the predicted incoming requests in the next time period with the determined current available capacity of the data processing system for processing the requests. In some implementations, the data processing system can determine that the current available capacity of the data processing system is sufficient to process the predicted number of incoming requests for the next time period if the total resource utilization value of the predicted incoming requests in the next time period is less than or equal to the current available capacity of the data processing system for processing the requests. Conversely, the data processing system can determine that the current available capacity of the data processing system is insufficient to process the predicted number of incoming requests for the next time period if the total resource utilization value of the predicted incoming requests in the next time period is greater than the current available capacity of the data processing system for processing the requests.

In some implementations, the data processing system can determine that the current available capacity of the data processing system is sufficient to process the predicted number of incoming requests for the next time period if: R−C<=E, where R is the total resource utilization value of the predicted incoming requests in the next time period, C is the current available capacity of the data processing system 110 for processing the requests, and E is a predetermined error. Conversely, if R−C>E, the data processing system can determine that the current available capacity of the data processing system is insufficient to process the predicted number of incoming requests for the next time period. In some implementations, the data processing system can determine the predetermined error E based on historical values, trial and error, etc. In some implementations, the predetermined error E can be any number, for example, 100 RU, 20 RU, 1 RU, 0 RU, −2 RU, etc.

The method 300 can include, responsive to determining that the current available capacity of the data processing system is insufficient to process the predicted number of incoming requests, the data processing system assigning, using a prioritization policy, a prioritization value to the request based on the one or more attributes associated with the computing device (BLOCK 330). In some implementations, the prioritization policy can include a set of rules for assigning prioritization values to the request based on the one or more attributes associated with the client device from which the request was received. In some implementations, the prioritization policy can include one or more latency prioritization rules specifying a set of latency sensitivity levels. For example, the set of latency sensitivity levels can range from first level to a nth level, with the first level being the lowest latency sensitivity level and the nth level being the highest latency sensitivity level. In one example, the first level can be level 1 and the nth level can be level 10.

In some implementations, the data processing system can determine the latency sensitivity level of a request based on the one or more attributes associated with the client device. For example, the request can include the current status of an online game application executed on the client device. If the current status of the online game application indicates that the currently playing game is at a close stage (e.g., near the end of the online game when the scores of the two sides are close), the data processing system may assign a higher latency sensitivity level (e.g., a level 9 when the range is, for example, 1-10) to the request. On the other hand, if the current status of the online game application indicates that the online game is at the beginning of the game or the scores of the two sides are not close, the data processing system may assign a lower latency sensitivity level (e.g., a level 2 when the range is, for example, 1-10) to the request.

In some implementations, the data processing system can assign a prioritization value to the request based on the determined latency sensitivity level of the request. In some implementations, the prioritization values can range from a first value to a nth value (e.g., 1 to 10, or 1 to 100, or other ranges). In other implementations, the prioritization values can be represented in various other forms (e.g., percentages, e.g., 1% to 100%, etc.). In some implementations, the data processing system can assign to the request a prioritization value that is proportional to the determined latency sensitivity level. For example, the data processing system can assign to the request a prioritization value of 90 (in a scale from 1-100) if the determined latency sensitivity level is 9 (in a scale from 1-10).

In some implementations, the data processing system can include one or more geographic location prioritization rules for assigning prioritization values based on geographic locations. In some implementations, the data processing system can determine the geographic location of the client device based on one or more attributes associated with the client device, for example an Internet Protocol (IP) address of the client device, a device identifier of the client device, a HTTP cookie associated with the client device, or information (e.g., login information) provided by the user of the client device. In some implementations, if the data processing system determines that a request is received from a client device located at a geographic location from where a number of other requests have also been received within a certain time period, the data processing system may assign a lower prioritization value (e.g., a value of 1 in a range 1-100) to the request. In such a case, the request may be identified as part of a Denial of Service attack. By assigning a lower prioritization value to the request, adverse effects resulting from such an attack on the data processing system can be reduced.

In some implementations, the data processing system can include one or more performance prioritization rules for assigning prioritization values based on one or more performance metrics associated with the client device. In some implementations, the data processing system can obtain the performance metrics associated with the client device by searching the database using the one or more attributes associated with the client device. For example, the data processing system can use a device identifier and/or an identifier in a HTTP cookie received along with the request to search the database. In some implementations, the database can store performance metrics of an action performed by the client device or a user identifier associated with the client device. For example, the action can be signing up a membership, clicking on a content item displayed on a web page at the client device, or purchasing a product on a web page displayed at the client device, etc. In some implementations, the performance metrics can include a click rate or a conversion rate indicating the likelihood that the user identifier at the client device may click on a content item or take an action with respect to a content item. In some implementations, the performance metrics retrieved from the database can indicate whether the client device performs an action successfully or unsuccessfully. In some implementations, the performance metrics can include a score indicating how well the client device performed the action. In some implementations, the data processing system can assign a prioritization value to the request based on the performance metrics. For example, the data processing system can assign to the request a prioritization value (e.g., a value of 90 out of 100) that is proportional to the performance metrics (e.g., a score of 9 out of 10) to the request.

In some implementations, the data processing system can utilize one or more machine learning models to determine the prioritization value of the received request. In some implementations, the data processing system can store the predicted prioritization values of requests over time, determine and store actual values of the requests, identify correlations between the predicted prioritization values and the actual values, identify features indicating characteristics and patterns of the requests, and adjust processes of predicting the prioritization values.

The method 300 can include, responsive to determining that the current available capacity of the data processing system is insufficient to process the predicted number of incoming requests, the data processing system determining a throttling threshold value (BLOCK 335). In some implementations, the throttling threshold value can be determined based on the current available capacity of the data processing system, the predicted number of incoming requests for the first time period, and the distribution of historical prioritization values. The distribution of historical prioritization values can correspond to a time period or can correspond to a finite number of historical requests. In some implementations, the data processing system can determine how many of the predicted number of incoming requests is to be throttled based on the current available capacity of the data processing system. For example, the data processing system can determine that half of the predicted number of incoming requests in the next time period should be throttled if the total resource utilization value of the predicted incoming requests in the next time period is twice the current available capacity of the data processing system.

In some implementations, the data processing system can use a distribution of historical prioritization values to locate the prioritization value. In some implementations, the data processing system can record historical prioritization values in the day before (or last week, last month, last hour, etc.) and store the recorded historical prioritization values to the database. In some implementations, rather than recording historical prioritization values within a time period, the data processing system can record historical prioritization values up to a finite number of historical requests. In some implementations, the data processing system can generate a distribution of the recorded historical prioritization values. For example, the data processing system can generate a distribution of the historical prioritization values corresponding to a second time period by arranging the historical prioritization values in the order from the lowest prioritization value to the highest prioritization value. In some implementations, the second time period corresponding to the distribution can have the same length as the first time period with which the predicted number of incoming request was determined, as described herein above. In some implementations, the second time period corresponding to the distribution can be a different time length as the first time period with which the predicted number of incoming request was determined. In some implementations, the data processing system can retrieve the distribution of historical prioritization values from the database. In some implementations, the data processing system can generate the distribution of historical prioritization values dynamically.

Continuing with the above example, the data processing system can use the distribution of historical prioritization values to locate the prioritization value which is at 50% of the distribution (e.g., approximately half of the historical prioritization values in the distribution is below this prioritization value). In some implementations, the data processing system can determine the throttling threshold value based on a distribution of historical prioritization values and one or more prior throttling threshold values determined using the distribution of historical prioritization values. Continuing with the above example, the prior throttling threshold value determined using the distribution of historical prioritization values is 35 (e.g., the range of the prioritization values is 1-100). In this example, the predicted number of incoming requests in the next time period is 2000. Using the throttling threshold value of 35, the data processing system may expect that approximately 1000 incoming requests (out of 2000 predicted number of incoming requests in the time period) are throttled. However, in this example, it turns out that only 500 incoming requests are actually throttled, indicating that the throttling threshold value of 35 is lower than it should be. Based on this information, when determining the next throttling threshold value using the distribution of historical prioritization values, the data processing system may adjust the throttling threshold value accordingly (e.g., adjusting the throttling threshold value to a value of greater than 35). In some implementations, the data processing system may adjust the throttling threshold value several times until finding a throttling threshold value that can generally throttle the number of incoming requests as expected or intended.

The method 300 can include the data processing system determining whether the prioritization value assigned to the request is below the determined throttling threshold value (BLOCK 340), and responsive to determining that the prioritization value assigned to the request is not below the determined throttling threshold value, the data processing system processing the request (BLOCK 345), and responsive to determining that the prioritization value assigned to the request is below the determined throttling threshold value, the data processing system throttling the request (BLOCK 350). In some implementations, the data processing system can throttle the request by skipping the processing of the request.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

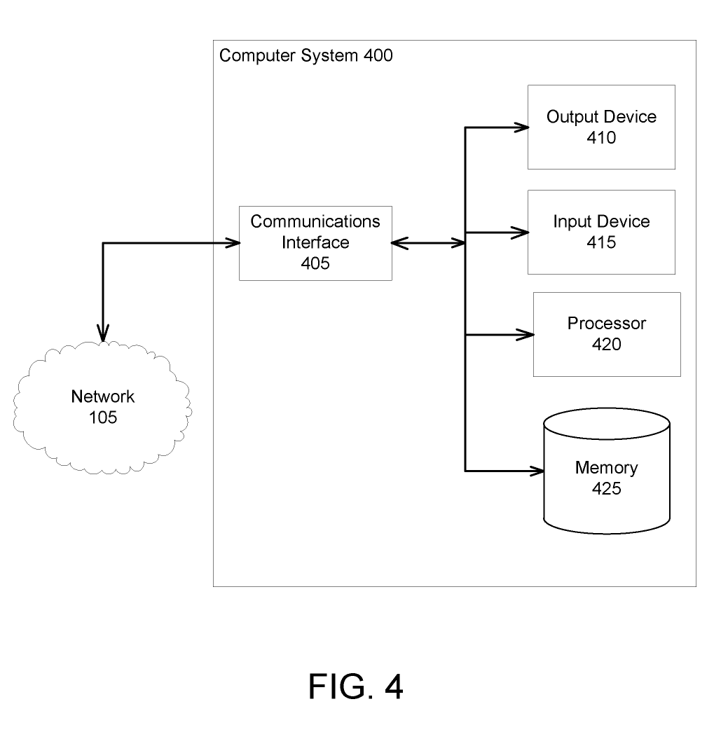

FIG. 4 shows the general architecture of an illustrative computer system 400 that may be employed to implement any of the computer systems discussed herein (including the system 110 and its components such as the request management engine 130, the request throttling engine 135, and request processing engine 140) in accordance with some implementations. The computer system 400 can be used to provide information via the network 105 for display. The computer system 400 of FIG. 4 comprises one or more processors 420 communicatively coupled to memory 425, one or more communications interfaces 405, and one or more output devices 410 (e.g., one or more display units) and one or more input devices 415. The processors 420 can be included in the data processing system 110 or the other components of the system 110 such as the request management engine 130, the request throttling engine 135, and request processing engine 140.

In the computer system 400 of FIG. 4, the memory 425 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 110 of FIG. 1, the data processing system 110 can include the memory 425 to store information related to the availability of inventory of one or more content units, reservations of one or more content units, among others. The memory 425 can include the database 145. The processor(s) 420 shown in FIG. 4 may be used to execute instructions stored in the memory 425 and, in so doing, also may read from or write to the memory various information processed and or generated pursuant to execution of the instructions.

The processor 420 of the computer system 400 shown in FIG. 4 also may be communicatively coupled to or control the communications interface(s) 405 to transmit or receive various information pursuant to execution of instructions. For example, the communications interface(s) 405 may be coupled to a wired or wireless network, bus, or other communication means and may therefore allow the computer system 400 to transmit information to or receive information from other devices (e.g., other computer systems). While not shown explicitly in the system of FIG. 1, one or more communications interfaces facilitate information flow between the components of the system 400. In some implementations, the communications interface(s) may be configured (e.g., via various hardware components or software components) to provide a website as an access portal to at least some aspects of the computer system 400. Examples of communications interfaces 405 include user interfaces (e.g., web pages), through which the user can communicate with the data processing system 110.

The output devices 410 of the computer system 400 shown in FIG. 4 may be provided, for example, to allow various information to be viewed or otherwise perceived in connection with execution of the instructions. The input device(s) 415 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The request management engine 130, the request throttling engine 135, and the request processing engine 140 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 400 or system 110 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the present disclosure or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the request management engine 130, the request throttling engine 135, and the request processing engine 140 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to throttling incoming network traffic requests in a computer network environment, the systems and methods described herein can include those applied to other environments. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A method of throttling incoming network traffic requests, comprising:
receiving, by a data processing system comprising one or more processors, a request from a computing device via a computer network, the request comprising one or more attributes associated with the computing device;
determining, by the data processing system, a predicted number of incoming requests for a first time period;
determining, by the data processing system, a current available capacity of the data processing system for processing incoming requests;
determining, by the data processing system, that the current available capacity of the data processing system is insufficient to process the predicted number of incoming requests;
responsive to determining that the current available capacity of the data processing system is insufficient to process the predicted number of incoming requests,
(i) assigning, by the data processing system, a prioritization value to the request based on the one or more attributes associated with the computing device, and
(ii) determining, by the data processing system, a throttling threshold value based on the current available capacity of the data processing system, the predicted number of incoming requests for the first time period, and a distribution of historical prioritization values corresponding to a second time period;
determining, by the data processing system, that the prioritization value assigned to the request is below the determined throttling threshold value; and
throttling, by the data processing system, the request responsive to determining that the prioritization value assigned to the request is below the throttling threshold.

2. The method of claim 1, wherein the current available capacity of the data processing system is determined based on a memory capacity, a disk capacity, and a processor capacity of the data processing system.

3. The method of claim 1, wherein assigning the prioritization value further comprises:
determining a latency sensitivity level of the request; and
assigning the prioritization value to the request based on the determined latency sensitivity level of the request using a latency prioritization rule in a prioritization policy used to assign the prioritization value.

4. The method of claim 1, wherein assigning the prioritization value further comprises:
determining a geographic location of the computing device sending the request; and
assigning the prioritization value to the request based on the determined geographic location of the computing device using a geographic location prioritization rule in a prioritization policy used to assign the prioritization value.

5. The method of claim 4, wherein the geographic location of the computing device is determined based on an Internet Protocol (IP) address of the computing device.

6. The method of claim 1, wherein throttling the request further comprises skipping processing the request.

7. The method of claim 1, further comprising:
receiving, by the data processing system, a second request from a second computing device via the computer network during the first time period;
assigning a second prioritization value to the second request based on one or more characteristics of the second request;
determining, by the data processing system, that the second prioritization value assigned to the second request is above the determined throttling threshold value; and
processing, by the data processing system, the second request responsive to determining that the prioritization level assigned to the second request is above the throttling threshold.

8. The method of claim 1, further comprising:
receiving, by the data processing system, a third request from a third computing device via the computer network;
determining, by the data processing system, a second predicted number of incoming requests for a third time period;
determining the current available capacity of the data processing system for processing incoming requests;
determining that the current available capacity of the data processing system is sufficient to process the second predicted number of incoming requests; and
processing, by the data processing system, the third request responsive to determining that the current available capacity of the data processing system is sufficient to process the second predicted number of incoming requests.

9. A system of throttling incoming network traffic requests, comprising:
a memory; and
one or more processors coupled to the memory, the one or more processors configured to:
receive a request from a computing device via a computer network, the request comprising one or more attributes associated with the computing device;
determine a predicted number of incoming requests for a first time period;
determine a current available capacity of a data processing system for processing incoming requests;
determine that the current available capacity of the data processing system is insufficient to process the predicted number of incoming requests;
responsive to determining that the current available capacity of the data processing system is insufficient to process the predicted number of incoming requests,
(i) assign a prioritization value to the request based on the one or more attributes associated with the computing device, and
(ii) determine a throttling threshold value based on the current available capacity of the data processing system, the predicted number of incoming requests for the first time period, and a distribution of historical prioritization values corresponding to a second time period;
determine that the prioritization value assigned to the request is below the determined throttling threshold value; and
throttle the request responsive to determining that the prioritization value assigned to the request is below the throttling threshold.

10. The system of claim 9, wherein the current available capacity of the data processing system is determined based on a memory capacity, a disk capacity, and a processor capacity of the data processing system.

11. The system of claim 9, further comprising the one or more processors configured to:
determine a latency sensitivity level of the request; and
assign the prioritization value to the request based on the determined latency sensitivity level of the request using a latency prioritization rule in a prioritization policy used to assign the prioritization value.

12. The system of claim 9, further comprising the one or more processors configured to:
determine a geographic location of the computing device sending the request; and
assign the prioritization value to the request based on the determined geographic location of the computing device using a geographic location prioritization rule in a prioritization policy used to assign the prioritization value.

13. The system of claim 12, wherein the geographic location of the computing device is determined based on an Internet Protocol (IP) address of the computing device.

14. The system of claim 9, further comprising the one or more processors configured to throttle the request by skipping processing the request.

15. The system of claim 9, further comprising the one or more processors configured to:
receive a second request from a second computing device via the computer network during the first time period;
assign a second prioritization value to the second request based on one or more characteristics of the second request;
determine that the second prioritization value assigned to the second request is above the determined throttling threshold value; and
process the second request responsive to determining that the prioritization level assigned to the second request is above the throttling threshold.

16. The system of claim 9, further comprising the one or more processors configured to:
receive a third request from a third computing device via the computer network;
determine a second predicted number of incoming requests for a third time period;
determine the current available capacity of the data processing system for processing incoming requests;
determine that the current available capacity of the data processing system is sufficient to process the second predicted number of incoming requests; and
process the third request responsive to determining that the current available capacity of the data processing system is sufficient to process the second predicted number of incoming requests.

17. A non-transitory computer-readable medium having machine instructions stored therein, the instructions when executed by at least one processor, causing the at least one processor to perform operations comprising:
receiving a request from a computing device via a computer network, the request comprising one or more attributes associated with the computing device;
determining a predicted number of incoming requests for a first time period;
determining a current available capacity of the data processing system for processing incoming requests;
determining that the current available capacity of the data processing system is insufficient to process the predicted number of incoming requests;
responsive to determining that the current available capacity of the data processing system is insufficient to process the predicted number of incoming requests,
(i) assigning a prioritization value to the request based on the one or more attributes associated with the computing device, and
(ii) determining a throttling threshold value based on the current available capacity of the data processing system, the predicted number of incoming requests for the first time period, and distribution of historical prioritization values corresponding to a second time period;
determining that the prioritization value assigned to the request is below the determined throttling threshold value; and
throttling the request responsive to determining that the prioritization value assigned to the request is below the throttling threshold.

18. The non-transitory computer-readable medium of claim 17, wherein the current available capacity of the data processing system is determined based on a memory capacity, a disk capacity, and a processor capacity of the data processing system.

19. The non-transitory computer-readable medium of claim 17, wherein assigning the prioritization value further comprises:
determining a latency sensitivity level of the request; and
assigning the prioritization value to the request based on the determined latency sensitivity level of the request using a latency prioritization rule in a prioritization policy used to assign the prioritization value.

20. The non-transitory computer-readable medium of claim 17, wherein assigning the prioritization value further comprises:
determining a geographic location of the computing device sending the request; and
assigning the prioritization value to the request based on the determined geographic location of the computing device using a geographic location prioritization rule in a prioritization policy used to assign the prioritization value.
